(19) United States
(12) Patent Application Publication
(10) Pub. No.: US 2021/0046840 A1
(43) Pub. Date: Feb. 18, 2021

(54) METHOD OF OPERATING A CHARGING STATION FOR ELECTRIC VEHICLES

(71) Applicant: Wobben Properties GmbH, Aurich (DE)

(72) Inventor: Johannes Brombach, Berlin (DE)

(21) Appl. No.: 16/993,007

(22) Filed: Aug. 13, 2020

(30) Foreign Application Priority Data
Aug. 14, 2019 (DE) 102019121848.9

(51) Int. Cl. B60L 53/63; B60L 53/52; B60L 53/51

(52) U.S. Cl. CPC B60L 53/63; B60L 2240/72; B60L 53/51; B60L 53/52

(57) ABSTRACT

The disclosure concerns a method of operating a charging station for charging electric vehicles, wherein the charging station is connected to an electrical supply network at a network connection point, the electrical supply network has at least one distribution network and at least one higher network portion hierarchically above the distribution network, and the network connection point is connected to the distribution network, wherein the charging station obtains electric power as receiving power from the electrical supply network, the receiving power at the network connection point is limited in its level by an initial draw limitation to an initial power limit to limit a transmission power which is transmitted in at least one network branch of the electrical supply network, and if required the receiving power is increased above the initial draw limitation if the limitation in respect of the transmission power in the at least one network branch is ensured.

### BACKGROUND

### Technical Field

The present disclosure concerns a method of operating a charging station for charging electric vehicles. The disclosure also concerns a charging station for charging electric vehicles.

### Description of the Related Art

A charging station for charging electric vehicles can also be referred to as an electric filling station or filling station for electric vehicles. This means electric vehicles come to such a charging station to be charged with energy. For that purpose a certain power is required, which can also vary depending on the respective charge status and/or charging control means. If a plurality of vehicles are being charged at the same time, more specifically at a respective charging terminal of the charging station, they also require electric power for the charging procedure. The total of all those charging powers forms an overall charging power that the charging station therefore has to provide in total.

Electric power can be taken from an electrical supply network for the electrical supply to the charging station. For that purpose the charging station is connected to the electrical supply network at a network connection point. If there is no intermediate storage means in the charging station then the charging station has to take the respective total charging power from the electrical supply network by way of the network connection point.

In the case of use peaks at which a particularly large number of electric vehicles are to be charged in the charging station, the electric vehicles are to be charged particularly quickly and/or a particularly large number of electric vehicles are to be charged at a high charging power then the network connection point or the electrical supply grid can reach its design limit in regard to power to be delivered to the charging station.

That design limit of the network connection point can limit the total charging power and can possibly have the result that electric vehicles at the charging station can only be charged more slowly. That problem can be alleviated by such a limitation on the charging power being split as uniformly as possible to all electric vehicles which are just to be charged. The problem however is not resolved.

An intermediate storage means can be provided in the charging station for temporarily boosting the charging power. Such an intermediate storage means can be charged up when there is a low demand for charging power and provide a part of the total charging power when the demand is high. The total charging power is then composed of the network power which the charging station takes from the electrical supply network at the network connection point and the power delivered by the intermediate storage means.

Such a solution is basically appropriate because a charging station rarely has to deliver maximum charging power 24 hours a day, but the solution is also very expensive because sufficiently large intermediate storage means are costly and also have to be regularly maintained and sometimes also replaced.

### BRIEF SUMMARY

One or more embodiments are directed to techniques in which a charging station can provide as much charging power as possible at the lowest possible cost.

One embodiment is directed to the operation of a charging station for charging electric vehicles, wherein the charging station is connected to an electrical supply network at a network connection point. The electrical supply network has at least one distribution network and at least one higher network portion hierarchically above the distribution network. The network connection point is connected in that arrangement to the distribution network. The at least one distribution network can be for example a low-voltage network or medium-voltage network and for that purpose there can be provided further distribution networks which are also low-voltage networks or medium-voltage networks.

Associated with that one or more distribution networks is a higher network portion which in particular can also have a higher voltage level than the distribution networks. If the distribution networks are low-voltage networks then the higher network portion can be in particular a medium-voltage network or a medium-voltage network portion. If the distribution networks are already medium-voltage networks then the higher network portion can be a high-voltage network to which the distribution networks are connected.

Taking that network topology as the basis the charging station is therefore connected to the distribution network by way of its network connection point and takes electric power by way thereof as receiving power from the electrical supply network. The receiving power at the network connection point is limited in its magnitude to an initial power limit by an initial draw limitation. The reason for that limitation on the receiving power is that a transmission power which is transmitted in at least one network branch of the electrical supply network is to be limited.

For that purpose it is proposed that if required the receiving power is increased above the initial draw limitation if the limitation on the transmission power is ensured in the at least one network branch. The network branch can then be part of the higher network portion or the network branch can correspond to a transmission node. The transmission node can be a transmission node from the distribution network to the higher network portion.

This is based on the realization that it is also possible to increase the receiving power at the network connection point without a transmission power which is to be actually limited thereby being increased, at least without it being increased above a limit provided for same. More specifically here the basic situation is that the limitation on the receiving power is intended to limit the transmission power. The receiving power should therefore not be increased above its limit, namely the initial power limit, because in that case it is assumed that the transmission power is consequently increased above its limit. In that respect it is assumed that, to provide the receiving power a corresponding power also has to be transmitted at another location in the electrical supply network, namely the transmission power or a part of the transmission power. The assumption was therefore that the increase in the receiving power therefore necessarily leads to an increase in the transmission power and also that, when the limit for the receiving power is exceeded, the consequence is that a limit of the transmission power is exceeded.

Here however it was now recognized that such a relationship does not have to apply, at any event not when the network connection point is connected to the distribution network, on which at least one higher network portion is superimposed. More specifically in this case the fact is to be considered that the receiving power or a part thereof can be provided in some other way than by way of the specified and limited transmission power. If therefore adapted provision of the receiving power is implemented then the receiving power can be increased above the initial draw limitation without the limited transmission power exceeding its limit. The limitation on the transmission power in the at least one network branch can therefore nonetheless be guaranteed.

In this way therefore the receiving power of the charging station can be increased by appropriately making use of the network topology involved. In that way a charging power of the charging station can also be correspondingly increased without an intermediate storage being required in the charging station, which naturally could nonetheless be provided as a supplemental measure.

It was realized that the problem may occur, that the initial draw limitation often is not necessary or its purpose can be achieved differently. The purpose is the protection of the network branch from a too high transmitted power. It was realized that such protection often can be reached differently, namely in particular if power can be received from a feed-in means or device nearby and if the power does not need to pass the network branch. Thus, according to one aspect, the initial draw limitation is received from externally, in particular from a grid operator.

According to an embodiment it is provided that if required the receiving power is increased above the initial draw limitation if the limitation on the transmission power in the at least one network branch can be achieved by power reallocation in the electrical supply network or if the transmission power in the at least one network branch can be reduced by that or another power reallocation in the electrical supply network. Both variants can also be implemented at the same time.

Power reallocation can be achieved by a feed-in being effected in the at least one network branch. For example a wind turbine can be connected to the one network branch and can feed the power directly into that network branch when there is sufficient wind. That feed-in can then lead to power reallocation, more specifically in the sense that the receiving power can be at least partially taken directly from that power which is fed into the network branch. The transmission power therefore no longer needs to be transmitted completely by way of a transfer point to another network branch or to the higher network portion because a part originates directly from the feed-in means, that is to say the wind turbine which has been specified by way of example.

In that respect reallocation of power takes place. The transmission power in the at least one network branch is reduced thereby because a part of the power now originates from the above-mentioned feed-in means. The receiving power can thus be increased by that part of the power that originates directly from the feed-in means without the transmission power exceeding its limitation.

In addition or alternatively it can also be considered that reallocation of the power is effected in such a way that the topology of the electrical supply network, in particular the at least one network branch and possibly also the higher network portion, is altered. It is possible for example temporarily to connect a connecting line or a connecting branch between the at least one network branch and the higher network portion. A part of the receiving power can then be passed by way thereof and the transmission power is reduced by that part and could thus be correspondingly also increased again by that value without exceeding its limitation. That is also power reallocation.

Such measures therefore provide that the transmission power can be reduced whereby the receiving power can be increased. The reallocation however can also be such and in particular can be precisely effected in such a way that the transmission power remains at its limit and only a respective further increase in the receiving power is satisfied by way of that reallocation.

According to a further configuration it is proposed that the receiving power if required is increased above the initial draw limitation when a regenerative feed-in means feeds power in a load flow path to the charging station, in which case in particular the receiving power is increased in dependence on the power which is fed in on the load flow path. Such a load flow path can extend from the higher network portion or a transmission node to the charging station. The transmission node can be a transmission node to the higher network portion. It has already been described that this can be one possible option for power reallocation. Here it is particularly proposed that at least one regenerative feed-in means, in particular a wind turbine or a wind farm, is connected in a load flow path from the transmission network to the charging station. The initial limitation on the receiving power, therefore the initial draw limitation, can be limited to an initial power limit which is to be observed if the regenerative feed-in means, in particular therefore the wind turbine or the wind farm, does not feed in any power. In the context of that draw limitation therefore at any event the charging station can be operated at any event independently of that regenerative feed-in means.

If however there is sufficient wind that the wind turbine or the wind farm generates electrical power from wind then that can be additionally provided to the charging station and the receiving power can be increased by that value above its initial draw limitation. The regenerative feed-in means however does not need to provide its power or all its power for the charging station but it can also feed it into the electrical supply network independently of the charging station. It is here only the local proximity between the regenerative feed-in means and the charging station that is utilized in order to be able to exceed the initial draw limitation on occasions.

It is also possible to provide a plurality of installations as the regenerative feed-in means, in particular a wind farm and a photovoltaic installation. Such a combination means that there is a much greater probability that at least one of the regenerative feed-in means generates electric power and feeds it into the load flow path. In that way the receiving power can then be frequently increased above the initial draw limitation. Particularly on the assumption that an increased demand for electric power occurs in the charging station, in particular at peak times and such peak times are usually not at night but in the day electric power should always be amply present at such peak times by virtue of at least one of the regenerative feed-in means.

According to an embodiment it is proposed that the receiving power if required is increased above the initial draw limitation if a regenerative feed-in means feeds reactive power in a load flow path to the charging station. Such a load flow path can extend from the higher network portion or a transmission node to the charging station. The transmission node can be a transmission node to the higher network portion. It is proposed in particular that in that case the receiving power is increased in dependence on the reactive power which is fed in on the load flow path.

It was realized in particular here that voltage profiles can be influenced by that reactive power feed from the regenerative feed-in means which therefore more specifically feeds in that reactive power in the proximity of the charging station. In that way in turn it is possible to at least partially control a power flow. It can be considered in particular that, the correspondingly more power that can be transmitted, the correspondingly greater was the voltage increased in the load flow path by virtue of the reactive power feed. The reason for this can be in particular that the voltage increase due to the reactive power feed counteracts a voltage drop due to the transmitted receiving power. In that way also it would be possible to control partial power reallocation whereby it is possible to guarantee the limitation in respect of the transmission power in the at least one network branch.

It was realized in particular that a power draw at the charging station above the initial draw limit can lead to such a severe voltage drop that the voltage in the load flow path departs from a prescribed voltage band and in particular drops below a lower limit. A reactive power feed by means of the at least one regenerative generating means can counteract that or obviate it. Preferably the charging station itself feeds in reactive power in order to counteract a voltage drop due to excessive power draw.

In an embodiment it is proposed that a check is implemented by way of at least one assessment criterion whether the limitation in respect of the transmission power in the at least one network branch is ensured. For checking purposes by way of the at least one assessment criterion at least one item of assessment information is used, which can preferably be obtained in at least one of the following ways.

The assessment function can be obtained by a network operator by the network operator therefore transmitting that assessment information to the charging station. The network operator usually has sufficient information regarding the load flows in the electrical supply network and can therefore judge whether the relevant transmission power in the at least one network branch is still below its limit. The network operator can thus transmit that information to the charging station.

Additionally or alternatively the assessment information can also be obtained from measurements, in particular from measurements of a prevailing wind speed and/or from measurements of a prevailing solar radiation. That applies in particular for the situation where a suitable regenerative feed-in means, that is to say a wind turbine or a wind farm, and/or a photovoltaic installation, provides the feed in the proximity of the charging station, in particular in the load flow path. If therefore such a regenerative feed-in means is the reason why the receiving power can be increased above the initial draw power, more specifically because appropriate power of such a regenerative feed-in means can be fed directly to the charging station, then on the basis of those weather values, that is to say the measured prevailing wind speed or the measured prevailing solar radiation, it is possible to judge how much power is available at least approximately from that regenerative feed-in means or a plurality thereof and can be fetched without an increase in the transmission power.

In addition or alternatively the assessment information can be obtained in the form of at least one signal from an adjacent wind farm and/or a wind farm connected to the load flow path. In addition or alternatively such information can be obtained in the form of at least one signal from an adjacent photovoltaic installation and/or a photovoltaic installation connected to the load flow path. Logically such a wind farm supplies information about the prevailing wind speed, whereas the photovoltaic installation provides information about the prevailing solar radiation. Alternatively the wind farm and/or the photovoltaic installation can also directly transmit its generatable power as the assessment information. It is then possible to judge from at least one of those items of assessment information whether more power is available for the receiving power than was limited by the initial draw limitation.

In an embodiment it is proposed that, to increase the receiving power as required above the initial draw limitation, power reallocation in the electrical supply network can be implemented or taken into consideration, in which power generated by at least one decentral feed-in means, or a part thereof, is fed to the charging station by way of the distribution network, without transmission by way of the higher network portion. In particular the feed of such power or a part thereof is effected from a wind turbine, a wind farm and/or a photovoltaic installation which respectively provide the generated power.

Here the underlying concept or assumption is that the transmission power at a transmission point from the higher network portion to the distribution network is limited. That transmission point is therefore the limiting element. Such a structure can frequently occur because more specifically such a higher network portion can be a transmission network or can form a connection from the distribution network to a transmission network. In that case it is usually assumed that power for the consumers, here more specifically for the charging station, is provided by way of the transmission network. The power therefore has to be transmitted by way of that transmission point.

The power consumption of the consumers of that distribution network is therefore limited in the light of the limitation on the transmission power, more specifically in the light of the limitation on the transmission capability of that transmission point. In the simplest case the charging station can be the sole consumer and its receiving power is then logically limited with its initial draw limitation to the limitation in respect of the transmission power. It is now considered however that a regenerative feed-in means can be supplemented on such a distribution network or such a feed-in means was already present, but nonetheless could not be taken into consideration in terms of limitation on the receiving power because more specifically it does not permanently feed in power in dependence on the wind and its lowest fed-in power is therefore zero. It is however now proposed that this also be taken into consideration.

It is also considered that a plurality of distribution networks, in particular at least two adjacent distribution networks, are connected together. If a decentral generating means or device provides a feed into an adjacent distribution network and that power or a part thereof can be directly transmitted into the distribution network to which the charging station is connected additional power can also be fed to the charging station by way of that path without increasing the transmission power. In that way the receiving power can therefore also be increased above its initial draw limitation without the transmission power coming to its limit for it is not increased in that situation.

According to an embodiment it is proposed that the charging station generates and outputs an increase signal which specifies a value or a value pattern in respect of time by which the receiving power can be increased above the initial draw limitation. Here the underlying concept is that in addition to the check as to whether an increase in the receiving power above the initial draw limitation is at all possible it is also communicated by the charging station whether it has experienced such an increase or wishes to implement such an increase or wishes to continue such an increase. The nature of the increase implemented, planned or continued can also be communicated here.

That can help in particular the network operator to whom such information can be transmitted to control the electrical supply network or a part thereof. Here the underlying concept is also that there can be provided a plurality of charging stations which are limited in their receiving power and the reason for that limitation in respect of the receiving powers of both charging stations is at least originally founded on the same transmission power. If now the receiving power can be increased by an increase power by virtue of the reallocation, feed-in from a decentral generating means or in some other fashion the problem can arise if both charging stations want to increase their receiving power by that increase.

To resolve that problem it could be provided in this case that each of the two charging stations can or may only increase its receiving power by half the increase power respectively. It frequently happens however that two adjacent charging stations do not simultaneously have the need to increase the receiving power above the initial draw limitation. That is considered in particular when such charging stations respectively form an electric filling station on a motorway or expressway at the same level but for different directions of travel. If for example there are increased flows of traffic in holiday periods these are usually only to be found in one direction. The same applies in relation to commuter traffic. It is therefore proposed that the charging stations communicate their need or their increase. It is then prevented that in the rare situation where both charging stations seek to increase their receiving power above their initial draw limitation, a conflict is recognized and can thereby be prevented. With such a communication there is no need for a precautionary limitation to 50% of the total possible increase to be implemented.

In an embodiment it is proposed that the charging station has a plurality of charging terminals, each charging terminal is adapted to charge an electric vehicle, each charging terminal plans ahead for a charging process for charging a connected electric vehicle, at least a part process thereof, a receiving power demand is ascertained from the charging processes of all charging terminals or the respective part process and for the receiving power demand a check is made as to whether it observes the initial draw limitation or whether the receiving power has to be increased over the initial draw limitation to cover the receiving power demand.

It was recognized here in particular that electric vehicles have very different charging characteristics and different electric vehicles frequently also have to be charged at the same time at a charging station, in which case once again the charging operation is rarely started synchronously for all electric vehicles so that the charging curves are also each at different stages. For charging an electric vehicle there is provided a respective charging terminal to which a respective electric vehicle is connected. Such a charging terminal can also be a charging pole but a plurality of charging terminals can also be provided on a charging pole. A charging terminal is in particular the hardware required for charging the electric vehicle.

If now an electric vehicle is connected to a charging terminal the charging terminal will ascertain the ongoing progress of the charging operation. In that case it can ascertain the charging status of the corresponding electric vehicle as well as the type of electric vehicle. Depending thereon it is then possible to ascertain how in the ideal situation the procedure in respect of time of the electric vehicle charging operation will be established. That time procedure thus forms the charging progress. Preferably the charging progress is planned ahead only in respect of a part and such a part, that is to say a time portion thereof, is a part procedure.

It is particularly advantageous if only one part procedure is planned ahead for all part procedures are to be respectively taken into consideration in combination. Such a part procedure and thus all part procedures of all charging terminals can be determined for current time periods, for example for the coming minute or for the coming five minutes or for the coming quarter of an hour, that is to say in particular for the coming time in the range of 1 minute to 15 minutes. In that way part procedures can be provided for that time range of each charging terminal. That takes account of the fact that frequently electric vehicles are not connected at the same time but are connected at different times, in particular a charged electric vehicle is disconnected from its charging terminal and then a fresh electric vehicle to be charged is connected, at different times. The overall charging procedures, therefore the complete charging process for an electric vehicle, are therefore not usually coincident in respect of time from one terminal to the next. The problem can be overcome by the use of the part procedures.

Such part procedures then take account in particular of the charging characteristic to be expected. Possibly it is also additionally possible to take account of a charging wish on the part of the electric vehicle or its driver.

The receiving power requirement can then be ascertained from all part procedures in combination and a check is made for same to ascertain whether an increase in the receiving power above the initial draw limit is necessary and, if so, of what level and for what period of time. On the basis thereof it is then possible to check whether such an increase is entirely or partially possible.

According to another embodiment there is also proposed a charging station for charging electric vehicles, wherein:

the charging station has a plurality of charging terminals,

each charging terminal is arranged for charging an electric vehicle,

each charging terminal plans ahead a charging procedure for charging the respectively connected electric vehicle, at least a part procedure thereof,

a receiving power demand is ascertained from the charging procedures of all charging terminals or from the respective part procedure, and

for the receiving power demand a check is run to ascertain whether it observes the initial draw limitation or whether the receiving power has to be increased above the initial draw limitation to cover the receiving power demand.

Such a control device can control a draw apparatus like for example an active rectifier which can be part of the charging station, in such a way that if required the receiving power is increased above the initial draw limitation if the limitation in respect of the transmission power is guaranteed in the at least one network branch. For that purpose the control device can process corresponding items of information and for example preset a suitable power target value for the draw device, in particular the active rectifier.

It can however also be considered that the control device controls or at least monitors all charging terminals at which a respective electric vehicle can be charged so that the maximum power consumption of the charging station does not exceed a suitable maximum value in respect of the receiving power. The control device then therefore monitors that the total of all charging powers of the charging terminals do not exceed that new higher receiving power limit. In particular it can be provided that, upon an increase in the receiving power for same a fresh limit is preset as an increased draw limitation and that increased draw limitation is proportionately distributed to the charging terminals as a limitation.

Preferably the control device only implements monitoring of all charging terminals. This can be carried out in such a way that basically all charging terminals may charge the respectively connected vehicle with so much power as is being requested by the corresponding electric vehicle at the moment. That total then gives the receiving power and for that a check is run as to whether it complies with the initial draw limitation. If it does not do so a check is run as to whether it leads to an increase in the receiving power, at which however the limitation in respect of the transmission power in the at least one network branch is still guaranteed. If that is not possible or is not possible at the necessary level then the control device can preset a suitable limit for the terminals.

Preferably the charging station and in particular the control device is adapted to carry out at least one method of operating a charging station in accordance with at least one embodiment as described hereinbefore. In particular it is also proposed that the charging station is so designed as was described in connection with a method according to at least one embodiment as described hereinbefore. In particular the charging station has the described charging terminals.

Preferably the charging station also has a communication device to receive and/or transmit information, in particular to transmit it to a network operator and/or to receive it from a network operator and/or to exchange information with a further charging station.

The charging station can be adapted to carry out a method according to at least one embodiment as described hereinbefore in particular by virtue of such a method being implemented in the control device. In particular the control device can have a processing computer in which such a method is programmed.

### BRIEF DESCRIPTION OF THE SEVERAL VIEWS OF THE DRAWINGS

The disclosure is described in greater detail hereinafter by means of embodiments by way of example with reference to the accompanying Figures in which:

FIG. 1 shows a perspective view of a wind turbine,

FIG. 2 shows a diagrammatic view of a section of an electrical supply network, and

FIG. 3 shows a diagrammatic view of a charging station.

### DETAILED DESCRIPTION

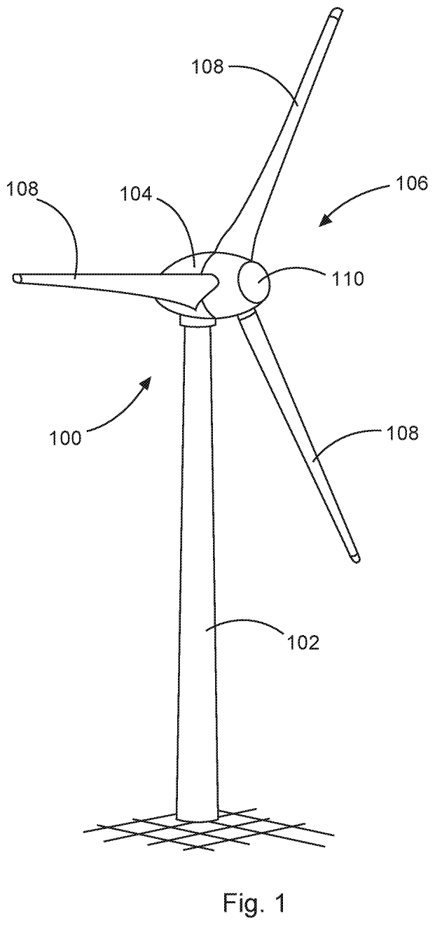

FIG. 1 shows a wind turbine 100 comprising a tower 102 and a nacelle 104. Arranged on the nacelle 104 is a rotor 106 having three rotor blades 108 and a spinner 110. In operation the rotor 106 is caused to rotate by the wind and thereby drives a generator in the nacelle 104.

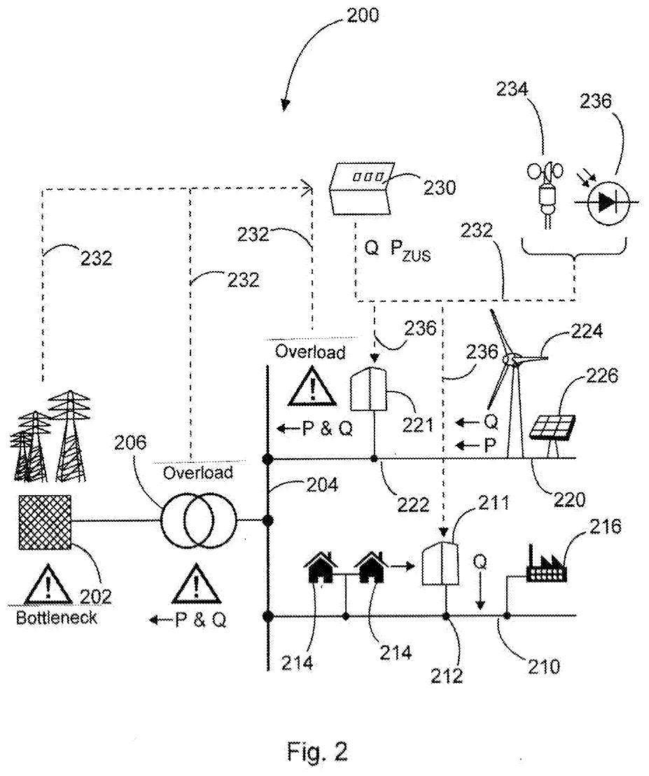

FIG. 2 shows a section of an electrical supply network 200 having a first distribution network 210 and a second distribution network 220 as well as a higher network portion 202 which is hierarchically above those two distribution networks. The two distribution networks 210 and 220 are connected to the higher network portion 202 by way of a bus bar 204 and a transformer 206. The transformer 206 transforms from a higher voltage in the higher network portion 202 to a lower voltage in the distribution networks 210 and 220. In addition a respective charging station 211 and 221 respectively is connected to each distribution network 210 and 220, more specifically in each case by way of a network connection point 212 and 222 respectively.

In addition further consumers or loads are connected to the first distribution network 210, more specifically two households 214 which are shown by way of example and which naturally can be different, and an industrial plant 216 like for example a factory. This serves for illustration purposes and further consumers or loads and also other elements can also be connected.

Also for the purposes of description connected to the second distribution network 220 are decentral feed-in devices, namely a wind turbine 224 and a photovoltaic installation 226.

Here account was now taken of the fact that charging stations can have a greatly fluctuating power requirement. A permanent configuration of a network connection point in relation to the maximum power demand may not be economically appropriate under some circumstances. It was now recognized here that regenerative feed-in devices can be present in the load flow path from the transmission network to the charging station and can cause an overload. In that case an additional load can have a load-relief action and can help to avoid a bottleneck.

That is to be clearly indicated in particular at the second distribution network 220 which here too is representative of a load flow path, namely one which extends from the bus bar 204 to the voltaic installation 226. If those two regenerative generating devices, that is to say the wind turbine 224 and/or the photovoltaic installation 226 provide a feed then this can be interpreted as an overload, more specifically because more power is fed into the second distribution network 220 than can be transmitted into the higher network portion 202. If the charging station 221 increases its power demand that acts like an additional load and can correspondingly absorb additional power which was being generated and fed in by the wind turbine 224 and/or the photovoltaic installation 226. The wind turbine 224 and also the photovoltaic installation 226 are therefore also representative of further such or other regenerative or at least decentral feed-in devices. In particular the wind turbine 224 can also be representative of a wind farm.

According to the disclosure it was realized that this topology can also be used to provide that the charging station 221 can increase its receiving power above an initial draw limitation or the initial power limit. That is possible when a part of the receiving power is being generated by the wind turbine 224 and/or the photovoltaic installation 226. It is then possible in that way to ensure that a limitation in respect of the transmission power, more specifically in particular in the transformer 206 and/or in the bus bar 204, is met.

In that way it can also be provided that the network connection power of the charging station 221 can be increased if that has a load-relief effect, or at least does not cause an excessive load. The network connection power can in that respect form an initial draw limitation for the receiving power of the charging station 221. Accordingly in the described situation the receiving power can be increased above that initial draw limitation and thus the network connection power.

It is thus proposed that an additional network connection power be enabled in dependence on the regenerative feed-in power in the load flow path, here therefore in the second distribution network 220. The initial power limit for the receiving power of the charging station 221 can therefore be increased in dependence on the regenerative feed-in power in the load flow path. There is thus proposed a consequential feed-in mode of operation in which more specifically the load or maximum load of the charging station follows the feed of the regenerative or decentral feed-in devices.

As a further possible option it is proposed that an additional network connection power be enabled in dependence on a reactive power loading in the load flow path. There is therefore proposed a consequential reactive power mode of operation which allows an additional load, that is to say allows the increase in the load or maximum load when reactive power is compensated.

If an overload occurs for example at a medium-voltage section that the second distribution network can form, by virtue of a high level of feed-in power of a photovoltaic installation and/or a wind turbine or a wind farm and if there is also a charging station at the medium-voltage section then a higher connection power can be associated therewith in dependence on the regenerative feed. That high level of feed from the regenerative feed-in devices can be effected for example by the wind turbine 224 and/or the photovoltaic installation 226.

For control purposes any bottleneck or a surplus of power from photovoltaic installations and/or wind turbines can be determined by a network operator and sent to the charging station as information. It can also be considered however, alternatively or in addition, that the charging station has sensors which can detect wind conditions and/or solar radiation. In dependence thereon such a charging station can then obviously follow an approximate feed with an additional connection power, that is to say a feed which can be estimated from the detected data relating to the wind conditions and the solar radiation.

It is particularly envisaged that the transformer 206 which thus also serves as a transmission node between the higher network portion 202 and the bus bar 204 or therewith the two distribution networks 210 and 220 forms a bottleneck. Basically the connection power of the charging stations 221 and 220 is designed for that bottleneck. The network connection power is thus the initial draw limitation of the receiving power of the respective charging station. That initial draw limitation is not to be increased because otherwise a limitation in respect of the transmission power at the transformer 206, therefore at the transmission node, could be exceeded there. It was now recognized however that, having regard to at least some decentral feed-in devices, in particular regenerative feed-in devices like the wind turbine 224 and the photovoltaic installation 226, a part of the power can come from there and the receiving power of the charging station, more specifically in particular the charging station 221, can be increased by that part above its initial draw limitation.

In that respect an increase in the receiving power above its initial draw limitation can be effected by reallocation. Therefore instead of obtaining the overall power from the higher network portion 202 by way of the transformer 206 and thus the transmission node the power supply is partially reallocated insofar as a part of the power is now obtained from the wind turbine 224 and/or the photovoltaic installation 226.

Another possible way of implementing power reallocation can also provide that a consumer or a load receives less power and instead that power can benefit a charging station. That is to be clearly illustrated with the first distribution network 210. If for example the industrial installation 216 reduces its power consumption because for example it needs less heating power in the Summer, or requires less power for technical reasons, or for example does not run 24 hours a day and 7 days a week, then that power can be to the benefit of the charging station 212. The charging station 212 can then increase its receiving power by that power that the industrial installation 216 is not using.

A further possible option provides that the first distribution network 210 obtains additional power from the second distribution network 220 which is not passed by way of the transformer 206 and therefore does not involve an additional loading on the transformer 206. In that respect reallocation of the power is then effected in such a way that only a part of the power required by the charging station 211 is obtained from the higher network portion 202. Another part of the power is obtained from the second distribution network 220, more specifically from the regenerative feed-in devices shown there, that is to say from the wind turbine 224 and the photovoltaic installation 226.

Reallocation however can also be effected in such a way that in actual fact a topology is modified by for example a cross connection being formed between the first distribution network 210 and the second distribution network 220. That is not shown in FIG. 2 but could be performed for example in the region of the photovoltaic installation 226 on the one hand and the industrial installation 216 on the other hand, by a cross connection being installed there and switched.

In particular a network management system 230 is proposed for controlling the described methods. Such a network management system can collect corresponding items of information which are necessary for carrying out the method, in particular information which is necessary in order to be able to judge whether the receiving power of the charging stations can be increased above its initial draw limitation without a transmission power exceeding a limitation. For that purpose such a network management system 230 can obtain information from the higher network portion 202 and also the transformer 206, namely the transmission node. It can also obtain information from the distribution networks, in particular from the second distribution network 220, as to whether an overload could be occurring there. Corresponding information paths 232 are indicated by broken lines. Not all possible information paths are shown. For example it is also envisaged that information can be obtained from the regenerative feed-in devices, therefore the wind turbine 224 shown by way of example and the photovoltaic installation 226 shown by way of example. Instead a variant is illustrated in that respect, in accordance with which the network management system 230 obtains information from a symbolically illustrated wind sensor 234 and a radiation measuring sensor 236.

In dependence thereon an increase in the initial draw limitation can be controlled by way of a respective control path 238 also shown in broken line. By way thereof a reactive power which is to be fed in or reactive power which is additionally to be fed in or reactive power to be taken from the charging station can be predetermined.

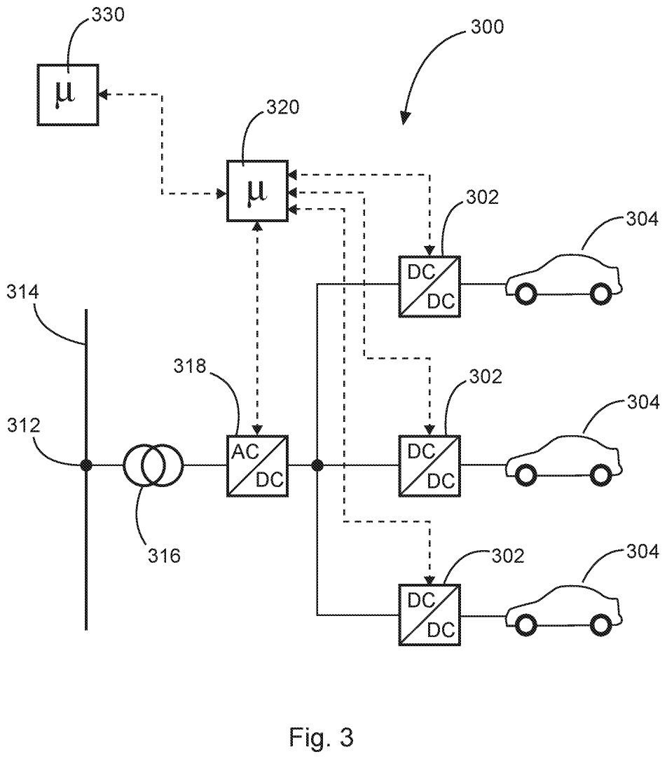

FIG. 3 is a diagrammatic view illustrating a charging station 300 with by way of example three charging terminals 302, to each of which a respective electric vehicle 304 is connected. The electric vehicles can naturally be different.

To power the charging station 300 it is connected by way of a network connection point 312 to an electrical supply network 314. The electrical supply network 314 has at least one distribution network and at least one higher network portion which is hierarchically above the distribution network, although this is not shown in FIG. 3, so for the network topology thereof attention is directed to FIG. 2 for the description thereof. The charging station 300 can correspond for example to the charging station 221 in FIG. 2 or the charging station 211 in FIG. 2.

For charging the electric vehicles 304 the charging station 300 takes a receiving power from the electrical supply network 314 by way of the network connection point 312. That can be effected by way of a charging station transformer 316, depending on what voltage the electrical supply network 314 has at the network connection point 312. Thus a receiving power is obtained by way of that network connection point 312, that power being rectified by way of a rectifier 318 and thus fed in the form of a direct current or a dc voltage to the charging terminals 302. Alternatively it is also possible to supply an ac voltage to the charging terminals 302 if the charging terminals are in the form of controlled rectifiers. It is more appropriate however in most cases to use dc chopper controllers as charging terminals, as is also indicated in the diagrammatic view in FIG. 3 for the charging terminals 302.

Each charging terminal 302 not only comprises the symbolically illustrated DC chopper controllers but also includes some control intelligence. Accordingly each charging terminal 32 can assess the charging status of the connected electric vehicle 304, assess the nature of the electric vehicle 304, and possibly also take account of a charging requirement on the part of the driver of the electric vehicle, in particular whether charging is to be fast or slow.

Each charging terminal 302 can use that information to determine a charging procedure and also determine a partial charging procedure in respect of the charging procedure. Such a part procedure can always be determined again afresh, for example every 5 minutes for a period of 5 minutes. Those part procedures can then be communicated to a charging station control system 320.

The charging station control system 320 can then assess whether an increase in the receiving power above the initial draw limitation is required. If it is required it can check whether an increase is possible. For that purpose a communication can be made with a network management system 330. The network management system 330 can correspond to the network management system 230 in FIG. 2. A check as to whether an initial draw limitation can be exceeded can be carried out in the way as was described in particular in connection with FIG. 2.

In dependence thereon the charging station control system 320 can actuate the charging terminals 302 and in particular can impart a limitation thereto and/or can actuate the rectifier 318 which in this case can be in the form of an active rectifier.

It is also envisaged that the charging station 300 and thus in particular its charging station control system 320 can firstly acquire information about an overload, therefore in particular a power surplus, and in dependence thereon provides an increase in the initial draw limitation. In dependence thereon actuation of the charging terminals 302 can then be effected or a limitation in respect of the charging terminals 302 can be set appropriately high. The rectifier 318 or active rectifier can also be controlled or limited in dependence thereon.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a charging station for charging electric vehicles, wherein:
the charging station is coupled to an electrical supply network at a network connection point,
the electrical supply network has at least one distribution network and at least one higher network portion hierarchically above the at least one distribution network, and
the network connection point is coupled to the at least one distribution network, the method comprising:
obtaining electric power as receiving power from the electrical supply network,
wherein the receiving power at the network connection point is limited by an initial draw limitation to an initial power limit to limit a transmission power that is transmitted in at least one network branch of the electrical supply network, and
if more power is required, increasing the receiving power above the initial draw limitation if the limitation with respect to the transmission power in the at least one network branch is ensured.

2. The method according to claim 1, wherein the initial draw limitation is received externally.

3. The method according to claim 1 wherein:
increasing the receiving power above the initial draw limitation, if:
the limitation with respect to the transmission power in the at least one network branch is achieved by power reallocation in the electrical supply network, and
the transmission power in the at least one network branch is reduced by the power reallocation in the electrical supply network.

4. The method according to claim 1, wherein the receiving power is increased above the initial draw limitation if at least one regenerative feed-in devices feeds in power in a load flow path to the charging station.

5. The method according to claim 4, wherein the receiving power is increased in dependence on the power fed in at the load flow path.

6. The method according to claim 1, the receiving power is increased above the initial draw limitation if at least one or the regenerative feed-in devices feeds in reactive power in a load flow path to the charging station.

7. The method according to claim 6, wherein the receiving power is increased in dependence on the reactive power fed in at the load flow path.

8. The method according to claim 1, further comprising:
performing a check by way of at least one assessment criterion whether the limitation with respect to the transmission power in the at least one network branch is ensured,
wherein performing the check comprises using for checking by way of the at least one assessment criterion at least one item of assessment information, and wherein the charging station obtains the assessment function from a network operator or from sensor measurements.

9. The method according to claim 8, wherein the sensor measurements are measurements of a prevailing wind speed or measurements of a prevailing solar radiation, or both.

10. The method according to claim 8, wherein the charging station obtains the assessment function as at least one signal from a wind farm or photovoltaic installation coupled to a load flow path.

11. The method according to claim 8, wherein the charging station obtains the assessment function as at least one signal from an adjacent photovoltaic installation or an adjacent wind farm.

12. The method according to claim 1, wherein to increase the receiving power above the initial draw limitation, load reallocation is carried out in the electrical supply network, wherein power produced by at least one decentral feed-in device is fed into the charging station by way of the at least one distribution network without transmission by way of the at least one higher network portion.

13. The method according to claim 1, comprising producing and outputting an increase signal specifying a value or a value pattern with respect to time, by which the receiving power is increased above the initial draw limitation.

14. The method according to claim 1, wherein:
the charging station has a plurality of charging terminals,
each charging terminal is arranged for charging an electric vehicle,
each charging terminal is configured to plan ahead a charging procedure for charging the respectively connected electric vehicle, the method further comprising:
ascertaining a receiving power demand from the charging procedures of all charging terminals or from the respective part procedure, and
wherein ascertaining the receiving power demand, a check is performed to ascertain whether the receiving power demand observes the initial draw limitation or whether the receiving power has to be increased above the initial draw limitation to cover the receiving power demand.

15. A charging station for charging electric vehicles, wherein:
the charging station is coupled to an electrical supply network at a network connection point,
the electrical supply network has at least one distribution network and at least one higher network portion hierarchically above the at least one distribution network,
the network connection point is coupled to the at least one distribution network,
the charging station is configured to obtain electric power as receiving power from the electrical supply network, and
the receiving power at the network connection point is limited by an initial draw limitation to an initial power limit to limit a transmission power that is transmitted in at least one network branch of the electrical supply network, wherein the charging station comprises:
a plurality of charging terminals; and
a controller configured to control a power draw from the electrical supply network in such a way that:
if more power is required, the receiving power is increased above the initial draw limitation if the limitation with respect to the transmission power in the at least one network branch is ensured.

16. The charging station according to claim 15, wherein:
each charging terminal is arranged for charging a respective electric vehicle,
each charging terminal is configured to plan ahead a charging procedure for charging the respectively connected electric vehicle,
the controller further being configured to:
ascertain a receiving power demand from the charging procedures of all charging terminals or from the respective part procedure, and
perform a check to ascertain whether the receiving power demand observes the initial draw limitation or whether the receiving power has to be increased above the initial draw limitation to cover the receiving power demand.

17. The charging station according to claim 15, wherein the controller is configured to receive the initial draw limitation from a grid operator.

18. The charging station according to claim 15, wherein the controller is configured to generator and output an increase signal specifying a value or a value pattern with respect to time, by which the receiving power is increased above the initial draw limitation.

19. A charging station comprising a control device configured to carry out the method according to claim 1.
